(19) United States
(12) Patent Application Publication
(10) Pub. No.: US 2007/0260543 A1
(43) Pub. Date: Nov. 8, 2007

(54) Electronic Ticket

(76) Inventor: Pierre Chappuis, Gumligen (CH)

Correspondence Address: Sanjay Agrawal;The Small Patent Law Group, 611 Olive Street, Ste. 1611, St. Louis, MO, 63101, US

(21) Appl. No.: 11/661,579

(22) PCT Filed: Oct. 14, 2005
(86) PCT No.: PCT/EP05/09460

§ 371 Date: Feb. 28, 2007

(30) Foreign Application Priority Data
Sep. 3, 2004 (DE) 20 2004 013 762.3
Oct. 21, 2004 (DE) 20 2004 016 344.6

(51) Int. Cl. G06Q 99/00

(52) U.S. Cl. 705/44

(57) ABSTRACT

The invention relates to a processing system for providing and inspecting an electronic ticket for a user that includes a control centre and a mobile terminal of the user. The control centre including means for generating the electronic ticket and for sending the electronic ticket to the mobile terminal, where the electronic ticket includes an encrypted part. The mobile terminal including means for receiving and for representing the encrypted part.

### BACKGROUND OF INVENTION

The present invention relates to a processing system for providing and inspecting an electronic ticket for a user.

The following discussion will first explain certain important concepts within the scope of the present specification.

The term “ticket” refers to a voucher which authorizes a user (or a plurality of users) to use a service provided by a transportation company, or authorizes the user to access a place or an event in the sense of an entrance pass or a “physical” pass for the user. For example, the ticket may be a travel pass, a plane ticket, a bus or underground ticket, a concert pass, a car parking ticket, a cinema ticket or any other comparable ticket.

The term “electronic ticket” (“e-ticket”) has for some time been part of common parlance, referring in many cases to the specific embodiment as an electronic flight ticket. For handling an electronic flight ticket of this type, the ticket is stored on an electronic storage medium, for example within an airline computer network. In the event of an inspection, (i.e., for example when the user checks in at the airport), the computer network provides the inspecting personnel with the information about the electronic ticket on-line at the airport.

The term “electronic ticket”, as used in the present specification, refers to a ticket which is in electronic form (i.e., is stored on an electronic storage medium), and therefore in principle does not necessarily have to be embodied in a material or a “physical” form (i.e., for example in paper form). The expression “paperless” is often used as short-hand to describe an electronic storage medium. In order to distinguish an electronic ticket from a ticket in a material or a physical form, (i.e., in a conventional form), the latter will be referred to as a “ticket in material form.”

Electronic tickets conventionally contain an item of information about the user of the ticket (i.e., for example the name of the user). Electronic tickets also contain an item of information indicating what the electronic ticket authorizes the user to do. For instance, the information may indicate a particular flight connection.

In handling an electronic ticket, a distinction can generally be drawn between two parts: first, the electronic ticket is provided, and second, the electronic ticket must be able to be inspected when the user uses the ticket. Both terms (e.g., providing an electronic ticket and inspecting an electronic ticket will be described in greater detail below.

FIG. 5 schematically shows the two parts: “provision” and “inspection”. The thick arrow shown in FIG. 5 symbolizes, in this case, the direction of the time characteristic. The electronic ticket is provided before the inspection process begins.

Two parties are involved in the provision and inspection: first, the user of the electronic ticket, and second, the party which produces or issues the electronic ticket (e.g., a transportation company). The “ticket-issuing party” will be referred to hereinafter as the “supplier.”

The provision stage generally starts with the user requesting and usually purchasing the desired electronic ticket from the supplier. The supplier than produces or generates the electronic ticket for the user. It is also generally possible for the user to make sure, once the electronic ticket has been generated or produced, that the electronic ticket has indeed been issued for him, as intended. Provision is generally made in this regard for corresponding “ticket information” to be transmitted to the user. The transmission of the ticket information can be started by the supplier or started by the user. For example, in the case of a flight ticket, a provision may be made for the supplier (i.e., in this case the airline) to send the ticket information to the user by e-mail, or a provision may be made for the user to independently access the ticket. For instance, the user may use the Internet to access the supplier's electronic memory where the user will then find the corresponding ticket information. Obviously, a combination of the two aforementioned types is also possible.

The production of the electronic ticket is a core element in a provision stage and is required. On the other hand, requesting ticket information and transmitting the ticket information to the user are optional elements of the provision stage. Handling is therefore generally successful even if the ticket is, for example, issued by the supplier on the user's behalf (e.g., unprompted by the user). The transmission of the ticket information is also not crucial, because the handling is successful even if the user simply assumes that the electronic ticket has been issued as intended (i.e., dispenses with the transmission of the ticket information).

Once the electronic ticket has been provided to the user, there is the option of an inspection. For example, in the case of a flight ticket, inspection can be performed when the user checks in at the airport. Generally speaking, the inspection will involve the user providing the supplier with an item of information which will prove that the user is the owner of the (valid) electronic ticket.

A basic advantage of an electronic ticket over a ticket in material form is that a user cannot, in the conventional sense, misplace, lose, or forget the electronic ticket. In addition, electronic tickets are also not sent to the user by mail, so there is no chance of the ticket becoming lost. Tickets in material form also require the use of a corresponding amount of material which is not necessary in the electronic form.

Nevertheless, these advantages may be offset by drawbacks: during the inspection, the supplier (i.e., for example the airline), generally requires that the user has “material identification,” such as photographic identification, a credit card, a driving license, a “frequent traveller card” and the like. In some cases, even a combination of a plurality of such forms of identification is required. The requirement of having identification decreases the advantage of being “paperless” for the user. In view of the overall system (i.e., provision and inspection of the electronic ticket), the “paperless” advantage no longer holds an advantage for the user. Moreover, by displaying his credit card, the user is disclosing relevant security information about himself, which may expose him in some cases to substantial risk of misuse.

In the case of an “electronic flight ticket,” the user has to carry his identification with him at the airport, so the aforementioned drawback of having paper information about himself need not necessarily be a disadvantage. Nevertheless, some scenarios that require a corresponding identification inspection may constitute an unjustified inconvenience for the user, as well as being very awkward to perform. Examples of such inconveniences would include inspecting a ticket and the user identification on a tram or train, a car parking place, a cinema, and the like.

International PCT application WO 2004/019581 A1 (hereinafter the '581 patent application) discloses a method of using an independent identification module, to identify a user of a mobile terminal and also to generate an action authorization for the user. The mobile terminal enables the user to request the action authorization from the identification module which then generates an action code, which is valid once and for a limited period of time, and is sent to both the user and to a terminal of a third party. To terminate the action, the user directly inputs a personal identification number (PIN) into the third party's terminal, sends the PIN to the third party's terminal directly, or sends the PIN via the identification module.

The method of the '581 patent application can also be used for buying an electronic ticket. For instance, a provision is made for the user to specify a tag number of a respective payment terminal, along with an “authorization request” at a (mobile or stationary) “e-ticketing” sales outlet. An action code is then sent, together with an “application PIN,” with which the user is familiar, from the identification module to the payment terminal. To terminate the process, the user inputs the application PIN at the payment terminal. An electronic ticket is subsequently produced and a receipt issued to the user as proof of purchase. The advantage of the method described by the '581 patent is that the user does not have to disclose any security-relevant information, such as for example, his credit card number to the third-party agency.

Nevertheless, in the event of an inspection, for example by a train conductor, the user still has—as stated above in the general case of the electronic ticket according to the prior art—to show identification to the inspecting personnel or else produce the printed proof of purchase. In view of the overall “provision and inspection” system, a “paperless” advantage is not achieved in this case either.

### SUMMARY

The object of the present invention is to disclose a processing system for providing and inspecting an electronic ticket. In particular, the system should be operable in a “paperless” manner and be easy to implement.

According to a first aspect of the invention, a processing system is provided for providing and inspecting an electronic ticket for a user. The processing system comprises a control centre and a mobile terminal, the user being able to access the mobile terminal. The mobile terminal may, for example, be a mobile telephone, a personal digital assistant (PDA), a palmtop computer and the like.

The control centre includes means for generating an electronic ticket and for sending the electronic ticket to the mobile terminal. The known as the short message service (SMS) of the global system for mobile (GSM) or another service having comparable properties may be provided. In this case, an electronic ticket supplier is able to use the control centre for this purpose.

According to the invention, the electronic ticket includes an encrypted part. The encryption process can therefore be carried out from the control centre when the electronic ticket is generated, wherein the control centre operator is basically able to choose any desired encryption code.

The mobile terminal includes means for receiving the electronic ticket and means for representing the encrypted part. For example, provision may be made for the encrypted part to be displayed on a display, for example on a display of the mobile terminal. It is also possible, for representing the encrypted part, for a different characteristic, such as a visual, an audible, or a tactile signal and the like to be generated by the mobile terminal.

In an embodiment, provision is made for the decryption code not to be disclosed to the user prior to the time of the inspection.

The system according to the invention therefore allows an electronic ticket to be provided for the user in that said ticket is generated by the control centre, for example at the user's request, and transmitted to the user's mobile terminal.

For the purposes of inspecting the electronic ticket, the encrypted part is represented using the mobile terminal and recorded by a human inspector or by an inspecting device.

In the case of inspection by a human inspector, the inspector is advised beforehand, for carrying out the method according to the invention, as to what the encrypted part must consist of in order to attest to the validity of the electronic ticket. For example, a provision may be made for the encrypted part to be represented on the display of the mobile terminal in the form of a specific string of characters. The human inspector is therefore aware, in this case, of which features this character string has to display in order to attest to the validity of the electronic ticket. In the case of an automatic inspection, provision is made for the decryption code to be input from the control centre into a corresponding inspecting device.

The processing system according to the invention therefore allows an entirely “paperless” method to be carried out for providing and inspecting an electronic ticket. In particular, there is no need for the user to show personal identification to the inspector, so he does not have to disclose any security-relevant data such as, for example, a credit card number and the like.

The mobile terminal includes means for displaying an item of information of the electronic ticket. The user can display the electronic ticket information, for example, on the display of the mobile terminal, as soon as he has received the electronic ticket. The information may be data allowing the user to determine what the electronic ticket authorizes him to do. In the case of a travel pass, the information may be, for example, the details of an initial stop and a destination stop, and an authorization period, if appropriate.

The mobile terminal includes a callable inspecting function that includes a decryption code for converting the encrypted part into a decrypted part. The decrypted part, for example, can be represented using the mobile terminal on a display.

For the purposes of inspecting, a provision is made for the inspecting function to be able to be retrieved by a human inspector or optionally by an inspecting device. The decrypted part, which can attest to the validity of the electronic ticket, is therefore subsequently displayed.

A provision is made for a code number, for example in the form of a PIN, to be required to be input in order to call up the inspecting function. The code number is not disclosed to the user prior to the time of the inspection. In order to carry out the inspection, the code number is disclosed to a human inspector or, if appropriate, the code number is input in a suitable manner into an inspecting device. This increases security or reduces the risk of misuse. For the purposes of implementation, the inspecting function is therefore called up and the code number input, for example by the inspector, whereupon the decrypted part is displayed. At least a portion of the decrypted part may, for example, comprise an item of ticket information.

The mobile terminal includes a memory in which an executable program can be stored for calling up the inspecting function. The memory is also physically secured to the mobile terminal or integrated into the mobile terminal. A provision may also be made for the memory to be provided to a further memory integrated in a SIM card of the mobile terminal, which facilitates the installation of a program. The program allows the user to request the electronic ticket via menu control, and optionally the program performs further steps.

The composition of the program is such that the program is based on an object-oriented, platform-neutral programming language. For example, the program may be based on a JAVA-type programming language or on a programming language having comparable properties. The program may, for example, be programmed in Java 2 Micro Edition (J2ME).

The program is a MIDlet or a program having comparable properties. The term “MIDlet” denotes a J2ME application for a mobile information device profile (MIDP) device. This allows the mobile terminal to be programmed wirelessly.

The control centre and the mobile terminal can be connected via a network, for example the Internet or an intranet. This allows the currently valid decryption code to be transmitted from the control centre to the mobile terminal, for example, within the inspection process. Alternatively, the encrypted part can be transmitted to the control centre in order to be decrypted and, once the decryption process has been completed, be sent back, as a decrypted part, by the control centre to the mobile terminal.

The mobile terminal also has functionality, for example a wireless application protocol (WAP) functionality that allows network contents (e.g., Web contents) to be provided wirelessly.

The programming of the mobile terminal, (e.g., the installation of the MIDlet), can also be carried out using the WAP network connection. Therefore, the MIDlet can be provided in a simple manner by the control centre for the user.

Using the above-mentioned program (e.g., MIDlet) allows the implementation of the inspection process to be integrated into the program. For example, a provision may therefore be made for the inspecting function to be retrieved by menu control (e.g., once the code number has been input by the human controller) and for the current decryption code to be transmitted via the built-up WAP connection or the decryption process to be carried out, as stated above, in the control centre.

The description code may be changed, for example, at specific intervals of time (e.g., for example daily), from the control centre. Thus, further reducing the risk of misuse.

The control centre includes means for accessing a user's account. The control centre may, for example, be connected to a database of a financial or credit institution via a network, so the user's account can be accessed and a transfer actuated on this communication path from the control centre. This allows a particularly simple processing of the purchase of the electronic ticket. The account may, for example, be a prepaid, a postpaid, a bank, a credit card account, and the like.

According to a further aspect of the invention, a processing system is provided for providing and inspecting an electronic ticket for a user. The system includes a control centre, a mobile terminal of the user, and a reading device. The mobile terminal includes a transmitter which is physically secured to the mobile terminal and is able to send out a device identification number. The device identification number is unambiguously associated with the mobile terminal. Furthermore, the reading device is configured to locally record the device identification number, for example within the range of vision or within reach. The control centre includes means for generating the electronic ticket in the event of unambiguous association between the electronic ticket and the device identification number.

The system therefore allows an electronic ticket to be provided for the user in that the said ticket is generated by the control centre at the user's request. The control centre establishes an unambiguous association between the electronic ticket and the device identification number. The device identification number accordingly has to be present in the control centre. For example, the user can, for this purpose, advise the control centre of said number in advance.

During an inspection, the reading device is then used to record the device identification number and to check, on the basis of the association information, whether an electronic ticket is valid for the recorded device identification number. A provision may be made, for example, for an inspector to become aware of the information based on the association between the electronic ticket and the device identification number. Using the reading device, the inspector is able to record the device identification number and to check, on the basis of the association, whether an electronic ticket is valid.

The processing system is suitable for performing an automatic method for the purposes of an inspection. A provision may be made for the user to guide his mobile terminal past the reading device which is at a “limit”.

The processing system therefore allows an entirely “paperless” method to be carried out for providing and inspecting an electronic ticket. In particular, there is no need for the user to present personal identification during the inspection process. Nor does he have to disclose any security-relevant data such as, for example, a credit card number and the like.

The transmitter is preferably in the form of a transponder that reacts to the reception of a beam emitted by the reading device by sending out its own beam that carries the device identification number information. The transponder may, for example, be a passive transponder which operates without its own power source and can consist of a metallic coil and a microchip. The device identification number being stored in the chip. The beam which is sent out by the reading device and received by the transponder, for example, may be a beam from the radio wave range (e.g., a beam having a frequency of 13.56 MHz.). Transponder technology is known in the art and will therefore not be examined in greater detail hereinafter.

The mobile terminal includes means for receiving and for displaying the electronic ticket. In particular, this enables the user immediately to examine the ticket information in a manner similar to that presented above with reference to the first aspect.

The control centre and the mobile terminal can be connected via a network, for example the Internet or an intranet.

The mobile terminal includes a memory in which there can be stored a program which is preferably based on an object-oriented, platform-neutral programming language. This allows installation, on the mobile terminal, of a program allowing particularly user-friendly operation, for example by way of menu control, for requesting and receiving electronic tickets.

The program is based on a JAVA-type programming language or a programming language having comparable properties. The program is also a MIDlet or a program having comparable properties. This allows the program to be provided from the control centre and transmitted to the mobile terminal, so the program is installed as an executable program in the mobile terminal memory.

The corresponding method according to the invention is used for providing and inspecting an electronic ticket for a user. According to a first aspect, the method is performed using a control centre and a mobile terminal of the user. The control centre includes means for generating the electronic ticket and for sending the electronic ticket to the user's mobile terminal. The electronic ticket includes an encrypted part. The mobile terminal includes means for receiving the electronic ticket and for representing the encrypted part.

In a first step, the control centre generates the electronic ticket including an encrypted part.

In a further step, the generated ticket is transmitted to the mobile terminal.

For the purposes of inspection, the encrypted part of the electronic ticket is represented, in a further step, using the mobile terminal.

If the inspection process is carried out by a human inspector, the inspector is advised beforehand as to what the encrypted part has to consist of in order to attest to the validity of the electronic ticket. This information is not disclosed to the user before the inspection is carried out.

The mobile terminal also has a callable inspecting function, the callable inspecting function including the decryption code with which the encrypted part of the electronic ticket can be decrypted. A code number, for example in the form of a PIN, has to be input in order to call up the inspecting function. For the purposes of inspection, the inspecting function is retrieved and the code number is input by an inspector or input by the user himself. A provision may optionally be provided for the code number to be disclosed not to the user, but rather to the inspector, for the purposes of carrying out the inspection of the electronic ticket.

The encrypted part of the electronic ticket is subsequently converted into the decrypted part and represented for the inspector on the mobile terminal display. Thus allowing the inspector to establish whether the electronic ticket is valid.

The control centre and the mobile terminal are connected, during the inspection process, via a network, for example via the Internet. For the purposes of inspection, the current decryption code is sent by the control centre to the mobile terminal, where it is used by the inspecting function. Alternatively, provision may be made for the encrypted part of the electronic ticket to be transmitted, via this connection, to the control centre, where it is decrypted and sent back, as the decrypted part, to the mobile terminal.

The control centre a changes the encryption code at specific intervals of time (e.g., daily).

The user uses the mobile terminal to request the electronic ticket before said ticket is produced, (e.g., in advance) by submitting a request message at the control centre.

Once the user has requested the electronic ticket, payment for the electronic ticket is carried out from the control centre, by transferring payment from the user's account.

Before the electronic ticket is requested, there is installed on the mobile terminal an executable program, for example in the form of a MIDlet. The executable program enables the user to conveniently carry out, for example by way of menu control, the steps which he has to actuate in order to carry out the method. The program can therefore, for example, be programmed to represent the ticket information and to call up the inspecting function.

The program can also be used to process the request for and the purchase of the electronic ticket in a user-friendly manner in that the corresponding account transaction and transfer are carried out at the user's request.

A program code number defined in advance by the user, for example in the form of a PIN, has to be input in order to call up the program.

An activation code, which is defined in advance by the control centre and transmitted to the user, has to be input in order to call up the program. Alternatively, the activation code is valid only once and/or valid for a limited period of time. The activation code can be transmitted to the user, for example by Internet connection.

A provision is also made for the creation at the control centre, in a prepared step, of a user profile containing, in addition to the user's personal details (e.g., his name and address), a record of the user's account and the mobile terminal call number.

According to a second aspect, a method is provided for providing and inspecting an electronic ticket for a user. The method is carried out using a control centre, a mobile terminal of the user and a reading device, the mobile terminal having an integrated transmitter which is able to send out to a mobile terminal device an identification number which can be recorded locally by the reading device.

For the purposes of operation, a provision is made for the device identification number to be transmitted to the control centre in a first step.

In a second step, the control centre produces the electronic ticket, for example at the user's request, with an unambiguous association with the device identification number.

In a further step, the association information is then transmitted to an inspection point.

For the purposes of inspection, the mobile terminal device identification number is recorded from the inspection point, using the reading device, and a check is performed, on the basis of the association information provided, as to whether an electronic ticket is valid.

The mobile terminal call number associated with the device identification number is also associated with said identification number, and this information is provided at the control centre. When the electronic ticket is requested, the user is then able to transmit the call number of the (“his”) control centre mobile terminal. There is therefore no need to name the corresponding device identification number within the ticket request process. In the control centre, the device identification number and the electronic ticket to be produced can then be unambiguously associated with the aforementioned call number. With regard to further method steps, reference is made to corresponding steps of the method according to the first aspect.

### BRIEF DESCRIPTION OF THE DRAWINGS

Further features, advantages and properties. will be described hereinafter on the basis of a detailed description of embodiments and with reference to the figures of the appended drawings, in which:

FIG. 1 is a symbolic illustration of the components of the processing system and of an operation chart for creating a new user profile at a control centre in accordance with an embodiment of the present invention;

FIG. 2 is an illustration of an operation chart for activating a user's account in accordance with an embodiment of the present invention;

FIG. 3 is an illustration of an operation chart for carrying out the inspection of the electronic ticket in accordance with an embodiment of the present invention;

FIG. 4 is an illustration of an operation chart in accordance with an embodiment of the present invention;

FIG. 5 is a symbolic illustration concerning the main operation in the provision and inspection of an electronic ticket according to the prior art, for the purposes of conceptual description in accordance with an embodiment of the present invention.

### DETAILED DESCRIPTION

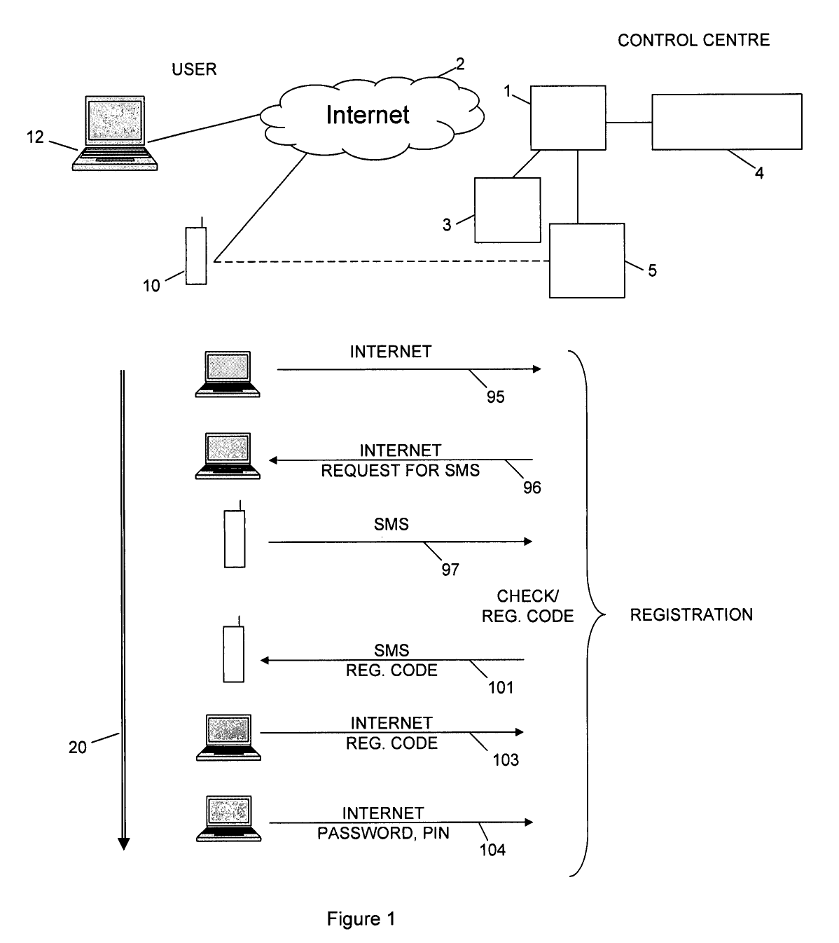

FIGS. 1 to 3 schematically illustrates a first embodiment of an operation according to the invention with a processing system according to the invention for providing inspecting an electronic ticket. A user of the electronic ticket and a control centre 1 are, in particular, involved in the method according to the invention.

As illustrated in FIG. 1, the system includes the control centre 1 which is used by an electronic ticket supplier but does not have to be managed or operated by the supplier himself. The control centre 1 has a server 3, which is connected to the Internet 2, and an SMS centre 5 allowing SMS messages to be sent. The control centre 1 is also connected to a database 4 of a financial or credit institution. This connection may be provided, for example, via the server 3. The user has an account at the financial or credit institution, and the user's account can be accessed via the database 4. Corresponding transfers can, in particular, be carried out through this channel. The control centre 1 also has an internal memory (not shown in detail in FIG. 1) in which the user's details can be stored in the form of a user profile.

In addition, the system includes a mobile terminal 10 with an SMS functionality, for example a mobile telephone, a personal digital assistant (PDA), a palmtop computer and the like. The user is able to access the mobile terminal 10 which will accordingly be referred to hereinafter for the sake of simplicity as “the user's mobile terminal 10”.

The mobile terminal 10 includes, in accordance with the first embodiment (not shown in the present case), a means for representing or displaying an electronic ticket or, more precisely, information of the electronic ticket. A display may be used for this purpose in a manner known in the art.

The mobile terminal 10 also has an Internet link, for example using a wireless application protocol (WAP) functionality, a standard for the provision of Web contents and other data-oriented services via wireless networks.

The mobile terminal 10 is also programmable. According to the embodiment not shown in the present case, the mobile terminal 10 accordingly supports a JAVA-type programming language, for example Java 2 Micro Edition (J2ME) or another programming language having comparable properties. The mobile terminal 10 also includes a memory in which there can be stored an application programmed in the corresponding programming language. In this case, the memory is independent of any SIM card of the mobile terminal 10.

The stored program or the stored application may, for example, be what is known as a MIDlet. A program of this type or an application of this type can be downloaded to the mobile terminal 10 using a WAP or Internet connection and stored in the memory. The MIDlet is then present as a program which the user is able to execute on the mobile terminal 10.

The user also has a PC 12 which is connected to the Internet and has e-mail software installed.

The system therefore allows the Internet to be accessed from the control centre 1. A website of the control centre 1 can therefore, in particular, be placed on the Internet 2 in this manner. The server 3 may be used for this purpose. An Internet connection to the user's PC 12 can also be produced via the Internet 2. An e-mail can, for example, be sent to the user via this connection. Furthermore, from the control centre 1, the SMS centre 5 can be used to send an SMS to the mobile terminal 10 and also to receive an SMS message from the mobile terminal 10.

An Internet connection to the control centre 1 can be established with the user's PC 12. A website placed on the Internet 2 by the control centre 1 can therefore, in particular, be accessed from the PC 12. From the mobile terminal 10, the user is able both to send an SMS message to the control centre 1 and to establish an Internet connection to the control centre 1 via WAP.

For carrying out the method according to the invention, a provision is made for the user initially to be registered at the control centre 1. The user has to be registered only once before the user requests an electronic ticket for the first time. The registration step does not have to be repeated for any further electronic tickets requested by this particular user. Once actuated, a user's registration remains valid until further notice.

The steps of the registration operation according to the invention are illustrated schematically at the bottom of FIG. 1. In FIG. 1, the thick arrow 20 shows the time characteristic of the indicated chart.

Within the registration process, the control centre 1 creates a “user profile” of the user. The user profile contains the user's personal details (e.g., his name and his address). The user profile also contains data concerning how the user can be contacted. For instance the user may be contacted by his mobile or cellular phone number (e.g., specified by the user) or by his mobile terminal 10. In addition, the user may be contacted by e-mail via which the user can be contacted via the Internet 2 using his PC 12. Finally, the user profile contains data concerning the user's account, (e.g., for example a corresponding account record), wherein this account can be accessed (e.g., account transactions can be initiated), from the control centre 1. The above-mentioned connection of the control centre 1 to the database 4 of the corresponding account-holding financial or credit institution is provided for this purpose. The account may also, for example, be a credit card account.

In a first step 95, a provision is made for carrying out the registration process by having the user to input on a corresponding website of the control centre 1 (e.g., via an Internet connection), the data necessary for creating the user profile.

The user profile data is stored, in the control centre 1, in the internal memory of control centre 1.

In a further step 96, the control centre 1 requests that the user send an SMS to the control centre 1 via his mobile terminal 10. This request may be made, for example, via the Internet, (e.g., by e-mail). In a further step 97, the user's mobile terminal 10 subsequently sends an SMS to the control centre 1 in response to a request.

Once the SMS of step 97 has been received, the control centre 1 identifies and checks the call number of the mobile terminal 10.

A provision may be made at this point for the call number of this latter SMS to correspond to that call number which was stored, within step 95, when the user profile was created. In this case, the check is deemed to be positive if these two call numbers correspond. This check measure significantly increases security, because the user has to specify two independent “addresses” in order to “identify” himself to the control centre. The addresses are in the form of an e-mail address and a mobile call number. There are also other possibilities for checking the mobile call number from the SMS transmitted to the control centre 1 in step 97. Alternatively, for example, “merely” a plausibility check may be provided.

If the result of the check turns out to be positive, the control centre 1 generates a registration code (“REG.CODE”) which is valid once. This code is then sent by SMS, in a further step 101, to the indicated mobile call number (i.e., to the user's mobile terminal 10). Alternatively, the registration code can be sent by e-mail to the user's specified e-mail address.

In a further step 103, the user then reads the registration code and enters the registration code again on the website of the control centre 1. Thus enhancing the security of the connection. Alternatively, a provision may be made for the user profile data not to be input until the registration code has been received.

In a further step 104, the user then chooses a password and a PIN and enters them, again on the website of the control centre 1. The password and the PIN are required when the user subsequently requests the electronic ticket.

With this data, the new user profile is therefore created in the integrated memory of the control centre 1. The registration process is thus completed.

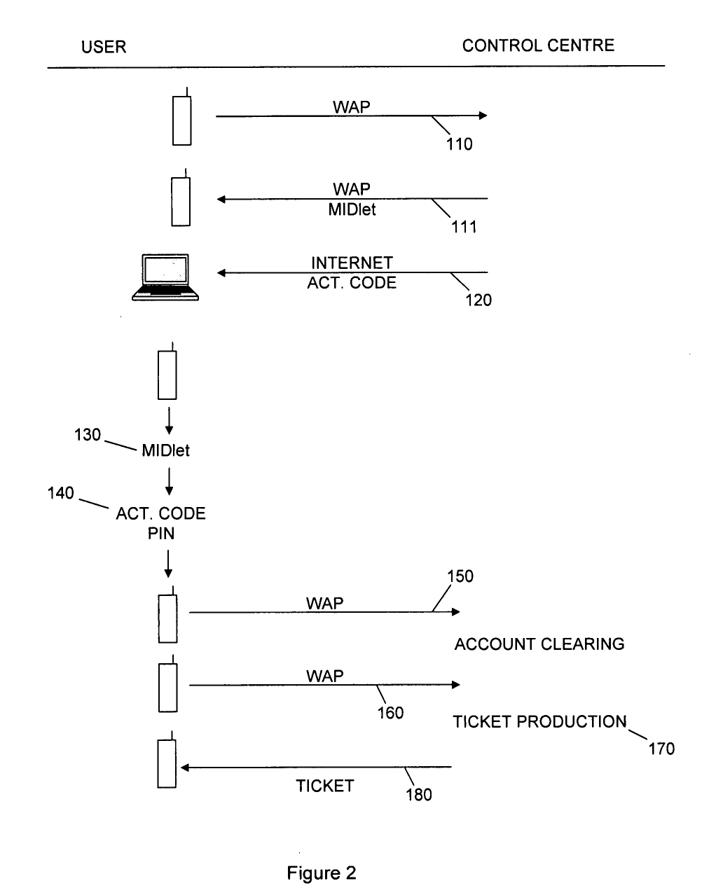

In a following stage of the method (shown in FIG. 2 as a continuation of FIG. 1), the user's mobile terminal 10 is equipped with an executable program allowing the subsequent provision and inspection of the electronic ticket to be performed by the user using, for example, menu control.

In accordance with the embodiment of the invention, step 110 has the user initially establish a WAP or Internet connection to the server 3 of the control centre 1. In a step 111, the user downloads to his mobile terminal 10 via the WAP or Internet connection a MIDlet provided by the control centre 1. The MIDlet may, for example, be a J2ME application for mobile information device profile (MIDP) devices. The MIDlet is, as stated above, stored or filed not on the SIM card of the mobile terminal 10 but rather in a further memory of the mobile terminal 10. The installed MIDlet is therefore a program which can be executed on the mobile terminal 10.

The program, referred to hereinafter as the MIDlet, is used to enable the user to request an electronic ticket from the supplier via the control centre. The MIDlet also enables the user to verify that the electronic ticket data, in particular an item of ticket information is correct and to indicate or present the electronic ticket data during an inspection.

The properties of the MIDlet will become apparent from the method steps described hereinafter.

As a security component, a provision is made for the above mentioned PIN, chosen by the user during the registration process, to have to be input in order to execute the MIDlet. There is therefore almost no risk of the MIDlet being misused by a person other than the user.

As a further security component, a provision is made for an activation code (“ACT.CODE”), which is valid only once for a limited period of time, to have to be input in order to execute the MIDlet. The control centre advises the user of the activation code in a further step 120, via the Internet, for example, using a protected region via the website of the control centre 1. In order to access the protected region of the website, a provision may be made for the user to have to input the above-specified password and the PIN on the website of the control centre 1.

In step 130, a provision is then made for the user to call up the MIDlet on the mobile terminal 10 to request an electronic ticket. The user inputs the activation code, which is valid only once and for a limited period of time, and the PIN. In step 140, if the activation code and PIN are both input correctly, in step 150, the MIDlet establishes a WAP connection to the server 3 of the control centre 1, where it produces a connection to the database 4 and then activates the user's account accordingly by clearing it. In step 160, once the clearing process has been successfully completed, the MIDlet enables the user to request and pay for an electronic ticket by menu control via the MIDlet.

The request for the electronic ticket contains the data necessary for producing the ticket (e.g., such as in the case of a travel pass), the indication of an initial stop, a destination stop, or a period of time during which the travel pass is to be valid. In the case of an “entrance pass”, the data may relate to the specification of the time and place of the corresponding event and the like.

In step 180, the electronic ticket is produced by the control centre 1, as on the basis of the data specified during the request, and transmitted to the user's mobile terminal 10 via the WAP connection or alternatively by SMS.

The corresponding transfer, which is required for purchasing the electronic ticket, from the user's account is also carried out from the control centre 1.

The MIDlet then converts the electronic ticket into a display which the user is able to read and can be represented on the display of the mobile terminal 10. The electronic ticket contains, an unencrypted part which represents the ticket information, (e.g., contains electronic ticket data) which is relevant to the user. For instance, in the example given above, ticket information relevant to the user includes the specification of the initial and destination stop, the validity of the ticket over a particular time period, and the like. The user is thus able to check this data as soon as he has received the electronic ticket.

The electronic ticket also contains an encrypted part. The code of the corresponding encryption is defined from the control centre 1 and the user is unaware of it. As a measure for further increasing security or reducing the risk of misuse, a provision may be made for the encryption code, with which the control centre 1 partially encrypts the electronic ticket, to be changed at certain time intervals (e.g., daily).

According to a first variation (variation I), this encrypted part is also displayed on the display. According to a second variation (variation II), there is no need for the encrypted part to be displayed on the display of the mobile terminal 10 in this step of the method.

In variation I, the user is requested, during an inspection of the electronic ticket, to present the electronic ticket on the display of his mobile terminal 10. This request may therefore be made, for example, by a human inspector, (e.g., for example, a train conductor) that a passenger, as the user of the mobile terminal to display the electronic ticket on the display of his mobile terminal 10.

The control centre 1 advised the inspector of the decryption code beforehand. The inspector is thus able to assess whether the electronic ticket displayed by the user on the display of his mobile terminal 10 does in fact originate from the control centre 1 and is valid.

In variation II, a provision is made for the mobile terminal 10 to have a callable inspecting function, the inspecting function containing the (currently valid) decryption code with which the encrypted part of the electronic ticket can be decrypted.

The inspecting function is preferably integrated in the MIDlet and can be called up by menu control. Calling up the inspecting function also requires, in particular, a code number, (e.g., an “inspecting code number”), for example in the form of a further PIN, which is known to the inspector for carrying out the inspection but not to the user.

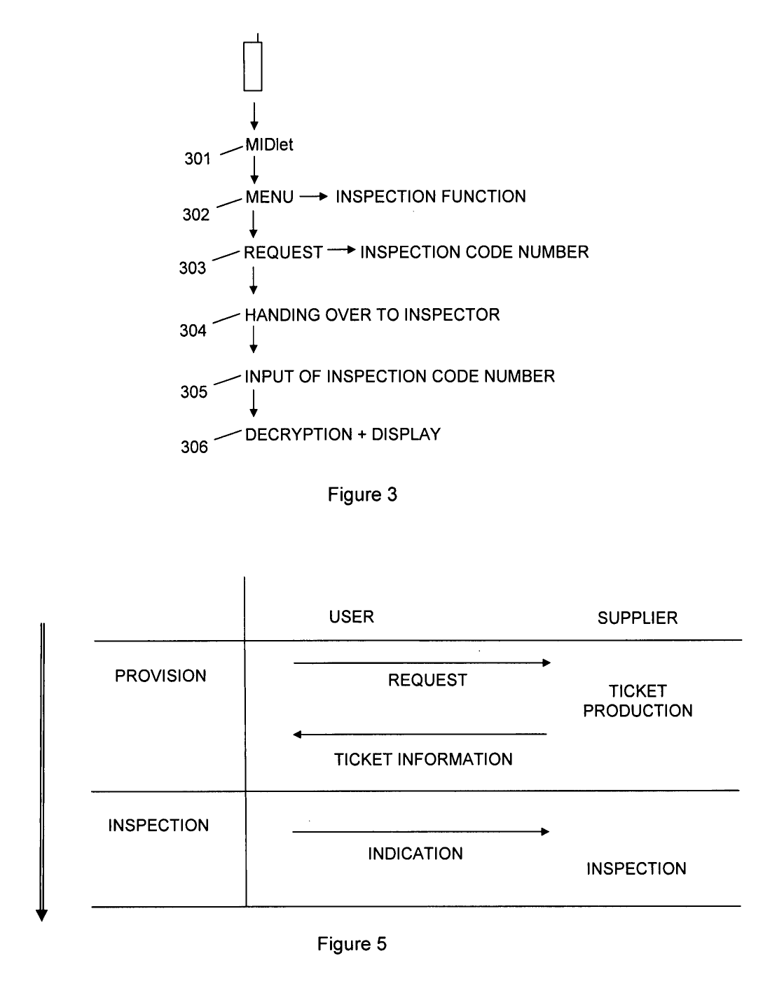

FIG. 3 schematically illustrates the corresponding process in accordance to an embodiment of the invention. According to this variation II, in step 301, the user to call up the MIDlet on his mobile terminal 10. In step 302, the inspecting function can then be called up by menu control. In step 303, a request to input the inspection code number is generated. In step 304, the user then hands over his mobile terminal 10 to the inspector. In step 305, the inspector inputs the inspection code number. In step 306, the encrypted part is decrypted by the inspecting function and represented on the display, so the inspector can easily establish whether the electronic ticket originates from the control centre 1 and is valid. At least a portion of the decrypted part may, for example, be the ticket information.

The inspection is therefore preferably carried out using the MIDlet and once the WAP or Internet connection has been established. In this case, the control centre 1 can transmit the decryption code via this connection to the mobile terminal 10, so said code is provided at this location for the purposes of decryption. Alternatively, a provision may be made for the decrypted part to be transmitted to the control centre 1, where it is decrypted and then sent back, as a decrypted part, to the mobile terminal 10. It is, in any case, therefore possible for a decryption code currently provided by the control centre to be used. The above-mentioned measure of changing the decryption code at certain time intervals therefore allows the risk of forgery to be almost eliminated.

The specified method allows, both in variation I and in variation II, entirely “paperless” processing for providing and inspecting an electronic ticket. The method is particularly simple for the user to implement.

According to a second embodiment, a provision is made, in contrast to the first embodiment, for the mobile terminal 10 to have an integrated transmitter, (e.g., a transmitter secured physically or “non-reversibly detachably” to the mobile terminal 10). The transmitter is able to send out a device identification number (referred to hereinafter as the identification number) which is unambiguously associated with the mobile terminal 10.

The transmitter may be, for example, a transponder, (i.e., a passive transponder, such as a transmitter which does not have its own power source) or in particular does not have a battery and consists of a metallic coil and a microchip. In this case, the identification number is stored in the microchip.

This identification number can be received using a suitable reading device. For this purpose, the reading device sends out a beam having a specific wavelength—for example in the radio wave range (e.g., 13.56 MHz)—which is received by the transponder. On receiving this beam, the transponder reacts by sending out the identification number. This identification number can be received using the reading device. A transponder of this type is also referred to as a smart label and is known as a radio frequency identification (RFID) unit. Transponder technology is known in the art and will therefore not be examined in greater detail hereinafter.

A system of this type comprising a reading device and transponder can, for example, have a range of up to 2 meters. The identification number of the mobile terminal can therefore be recorded as being “local” using the reading device.

According to the second embodiment, it is also not critical, in contrast to the first embodiment, for the mobile terminal 10 to have a display and the like. Nevertheless, a display is advantageous in this case, too, for simple checking of the ticket information by the user, as in the first embodiment.

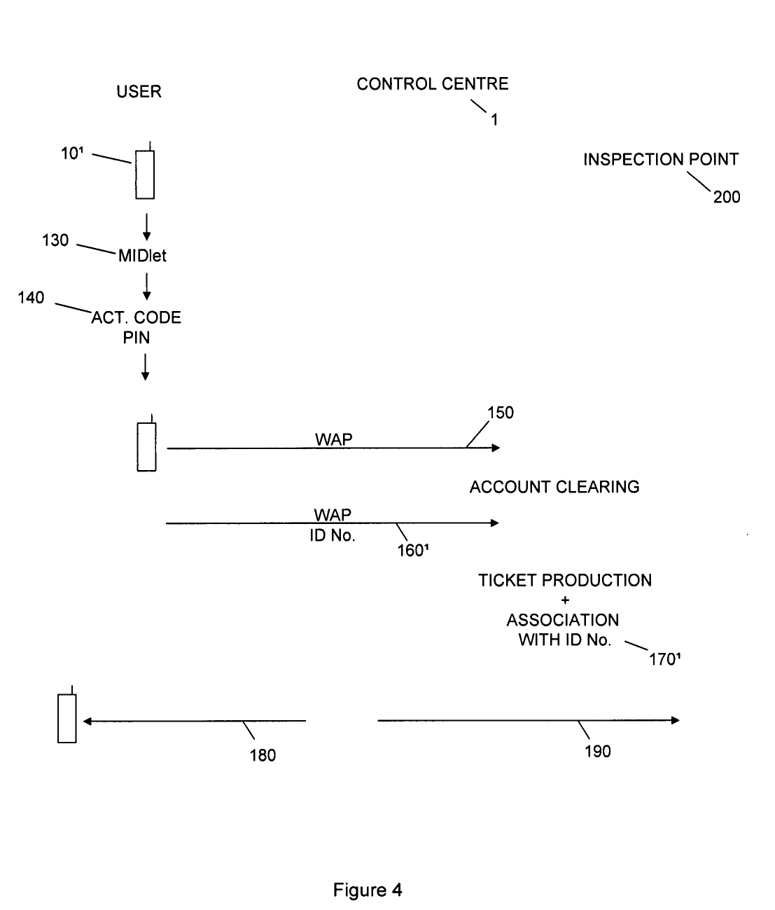

The operation according to the second embodiment will be described hereinafter in greater detail with reference to FIG. 4. The registration of the user and the activation or clearing of the account are carried out, in this case, as in the first embodiment. In step 150, the user also requests the electronic ticket, as in the first embodiment. However, in step 160, the identification number of the mobile terminal 10 is now additionally transmitted to the control centre 1. Alternatively, the identification number can obviously be transmitted in a different manner, for example within the registration process.

In contrast to the first embodiment, an unambiguous association between the electronic ticket and the identification number of the mobile terminal 10 is now established when the electronic ticket is produced.

As a further security measure, provision may also be made for the call number of the mobile terminal 10 to be incorporated, as a further component, into the association.

The association defined by the control centre 1 has to be known to the human inspector or, if appropriate, be present at the inspecting device when the electronic ticket is inspected. For this purpose, the electronic ticket is transmitted, together with the associated identification number, to an inspection point 200, for example using the Internet or an intranet of the control centre 1. The inspection point 200 is equipped with a corresponding reading device.

The inspection takes place at the inspection point. According to this second embodiment, the user is requested to guide his mobile terminal 10 past the corresponding reading device or to have the reading device guided past the mobile terminal 10, so the identification number of the mobile terminal 10 is therefore recorded using the reading device. The human inspector then checks (or the inspecting device checks automatically), on the basis of the association information provided, whether an associated electronic ticket is valid for the recorded identification number.

According to the second embodiment, the user therefore no longer has to identify himself to the inspector by presenting the display of his mobile terminal. The authorization can be carried out automatically by the corresponding reading device. The identification number can also be recorded wirelessly. The user therefore approaches, for the purposes of inspection, using his mobile terminal 10 a “limit” at the inspection point which wirelessly checks the authorization for the corresponding location and the corresponding time and, if authorization is established, opens the corresponding access (e.g., a “physical” limit).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein”. Moreover, in the following claims, the terms “first,” “second,” and “third,” etc. are used merely as labels, and are not intended to impose numerical requirements on their objects.

What is claimed is:

1. A processing system for providing and inspecting an electronic ticket for a user, comprising:
a control centre and a mobile terminal of the user, wherein the control centre includes means for generating the electronic ticket and for sending the electronic ticket to the mobile terminal, the electronic ticket includes an encrypted part; and the mobile terminal includes means for receiving and for representing the encrypted part.

2. The processing system according to claim 1, wherein the mobile terminal comprises means for displaying an item of information of the electronic ticket.

3. The processing system according to claim 1, wherein the mobile terminal has a callable inspecting function.

4. The processing system according to claim 4, wherein the inspecting function comprises a decryption code for converting the encrypted part into a decrypted part.

5. The processing system according to claim 1, wherein the mobile terminal comprises means for displaying the decrypted part.

6. The processing system according to claim 4, wherein performing the inspecting function requires a code number to be input.

7. The processing system according to claim 1, wherein the mobile terminal further comprises a memory in which a program can be stored for calling up an inspecting function.

8. The processing system according to claim 7, wherein the memory is physically secured to the mobile terminal or integrated in the mobile terminal.

9. The processing system according to claim 7, wherein the program is based on an object-oriented, platform-neutral programming language.

10. The processing system according to claim 7, wherein the program is based on a JAVA-type programming language or a programming language having comparable properties.

11. The processing system according to claim 7, wherein the program is a MIDlet or a program having comparable properties.

12. The processing system according to claim 1, wherein the control centre and the mobile terminal can be connected via a network.

13. The processing system according to claim 12, wherein the network is the Internet or an intranet.

14. The processing system according to claim 12, wherein the mobile terminal has a functionality allowing network contents to be provided wirelessly.

15. The processing system according to claim 1, wherein the mobile terminal is configured to have a wireless application protocol (WAP) functionality.

16. Processing system according to claim 4, wherein the decryption code can be changed from the control centre.

17. The processing system according to claim 1, wherein the control centre comprises means for accessing an account of the user.

18. The processing system according to claim 1, wherein the control centre is connected to a network, an account being accessible via the network.

19. A processing system for providing and inspecting an electronic ticket for a user, comprising:
a control centre, a mobile terminal of the user and a reading device, wherein the mobile terminal includes a transmitter physically secured to the mobile terminal, wherein the transmitter is configured to communicate a device identification number associated with the mobile terminal;
the reading device being configured locally to record the device identification number; and
the control centre including means for generating the electronic ticket in the event of an association between the electronic ticket and the device identification number.

20. The processing system according to claim 19, wherein the transmitter comprises a transponder.

21. The processing system according to claim 19, wherein the mobile terminal comprises means for receiving and for displaying the electronic ticket.

22. The processing system according to claim 19, wherein the control centre and the mobile terminal are connectable via a network.

23. The processing system according to claim 22, wherein the network is the Internet or an intranet.

24. The processing system according to claim 19, wherein the mobile terminal comprises a memory that stores a program based on an object-oriented, platform-neutral programming language.

25. The processing system according to claim 24, wherein the program is based on a JAVA-type programming language or a programming language having comparable properties.

26. The processing system according to claim 24, wherein the program is a MIDlet or a program having comparable properties.

27. The processing system according to claim 19, wherein the association is a unique association.
